(19) United States
(12) Patent Application Publication
(10) Pub. No.: US 2020/0310294 A1
(43) Pub. Date: Oct. 1, 2020

(54) DEVELOPING DEVICE, PROCESS CARTRIDGE AND IMAGE FORMING APPARATUS

(71) Applicant: CANON KABUSHIKI KAISHA, Tokyo (JP)

(72) Inventors: Shun Sato, Minamiashigara-shi (JP); Yasushi Katsuta, Tokyo (JP); Kohei Matsuda, Fujisawa-shi (JP); Kentaro Kawata, Suntou-gun (JP); Hiraku Sasaki, Susono-shi (JP); Hiroki Ogino, Mishima-shi (JP)

(21) Appl. No.: 16/819,277

(22) Filed: Mar. 16, 2020

(30) Foreign Application Priority Data
Mar. 29, 2019 (JP) 2019-065535

(51) Int. Cl. G03G 15/08

(52) U.S. Cl. CPC G03G 15/0874; G03G 15/0887; G03G 15/081

(57) ABSTRACT

A developing device includes a rotatable developer carrying member, a frame, a partition wall partitioning an inside of the frame into a developing chamber and a developer accommodating portion and provided with an opening, and a feeding member. The feeding member includes a flexible sheet member and a driving member. Maximum acceleration of the sheet member driven by the driving member in a first direction in which the developer in the developer accommodating chamber is moved toward the opening is smaller than maximum acceleration in a second direction opposite to the first direction. When the sheet member is reciprocated in a surface direction by the driving member, the sheet member is deformable so as to follow a shape of an inner wall surface of the developer accommodating chamber.

### FIELD OF THE INVENTION AND RELATED ART

The present invention relates to a developing device and a process cartridge for use with an image forming apparatus, and relates to the image forming apparatus including the developing device or the process cartridge.

In an image forming apparatus disclosed in Japanese Laid-Open Patent Application (JP-A) 2015-92226, a developer on a plate-like member can be fed by reciprocal movement of the plate-like member in a feeding surface direction.

However, in JP-A 2015-92226, an upper surface of the plate-like member was a uniform flat surface. In such a structure, the case where an inner wall surface of a developer accommodating chamber is formed by a curved surface or a plurality of flat surfaces would be also considered. In that case, a gap between a lower surface of the plate-like member and the inner wall surface of the developer accommodating chamber becomes large and a developer remains in the gap, and therefore, a problem such that the developer in the developer accommodating chamber cannot be efficiently fed to a developing chamber arose.

### SUMMARY OF THE INVENTION

The present invention has solved the above problem, and a principal object thereof is to provide a developing device, a process cartridge and an image forming apparatus which are capable of improving feeding efficiency of a developer.

According to an aspect of the present invention, there is provided a developing device comprising: a rotatable developer carrying member configured to carry a developer; a frame rotatably supporting the developer carrying member and configured to accommodate the developer; a partition wall configured to partition an inside of the frame into a developing chamber in which the developer carrying member is provided and a developer accommodating portion in which the developer is accommodated, the partition wall being provided with an opening permitting communication between the developing chamber and the developer accommodating chamber; and a feeding member configured to feed the developer from the developer accommodating chamber to the developing chamber through the opening, wherein the feeding member includes a flexible sheet member and a driving member configured to drive the sheet member so as to reciprocate in a surface direction, wherein maximum acceleration of the sheet member driven by the driving member in a first direction in which the developer in the developer accommodating chamber is moved toward the opening is smaller than maximum acceleration in a second direction opposite to the first direction, and wherein when the sheet member is reciprocated in the surface direction by the driving member, the sheet member is deformable so as to follow a shape of an inner wall surface of the developer accommodating chamber.

Further features of the present invention will become apparent from the following description of exemplary embodiments with reference to the attached drawings.

### BRIEF DESCRIPTION OF THE DRAWINGS

FIG. 1 is a sectional view showing a structure of an image forming apparatus.

FIG. 2 is a sectional view showing a structure of a process cartridge in a first embodiment.

Parts (a) to (c) of FIG. 3 are sectional views showing a structure of a developer accommodating unit in the First Embodiment.

FIG. 4 is a sectional view showing a structure of a developer container in a first comparison example.

Part (a) of FIG. 5 is a sectional view showing a structure of the developer container, in a second embodiment, part (b) of FIG. 5 is a sectional view taken along P-P line of part (a) of FIG. 5, and part (c) of FIG. 5 is a partially enlarged view of part (b) of FIG. 5.

FIG. 6 is a sectional view showing a structure of a developer container in a second comparison example.

FIG. 7 is a sectional view showing a structure of a developer container in a modified embodiment of the second embodiment.

Part (a) of FIG. 8 is a sectional view showing a structure of the developer container, in a third embodiment, part (b) of FIG. 8 is a sectional view taken along P-P line of part (a) of FIG. 8, and part (c) of FIG. 8 is a partially enlarged view of part (b) of FIG. 8.

### DESCRIPTION OF EMBODIMENTS

Embodiments of a developing device, a process cartridge and an image forming apparatus according to the present invention will be specifically described with reference to the drawings. However, as regards dimensions, materials, shapes, relative arrangements and the like of constituent elements described in the following embodiments, the scope of the present invention is not intended to be limited to the following embodiments unless otherwise specified. Further, in the following description, the materials, the shapes and the like which are described once are similar to those described later unless otherwise specified.

In the following description, a longitudinal direction of a process cartridge B is a rotational axial direction of a photosensitive drum 7 as an image bearing member. Further, left and right are left and right when the recording material 2 is seen from above with respect to a feeding direction of the recording material 2. Further, an upper surface of the process cartridge B is a surface positioned at an upper portion in a state in which the process cartridge B is mounted in an image forming position of an image forming apparatus 100, and a lower surface is a surface positioned at a lower portion in the state.

### First Embodiment

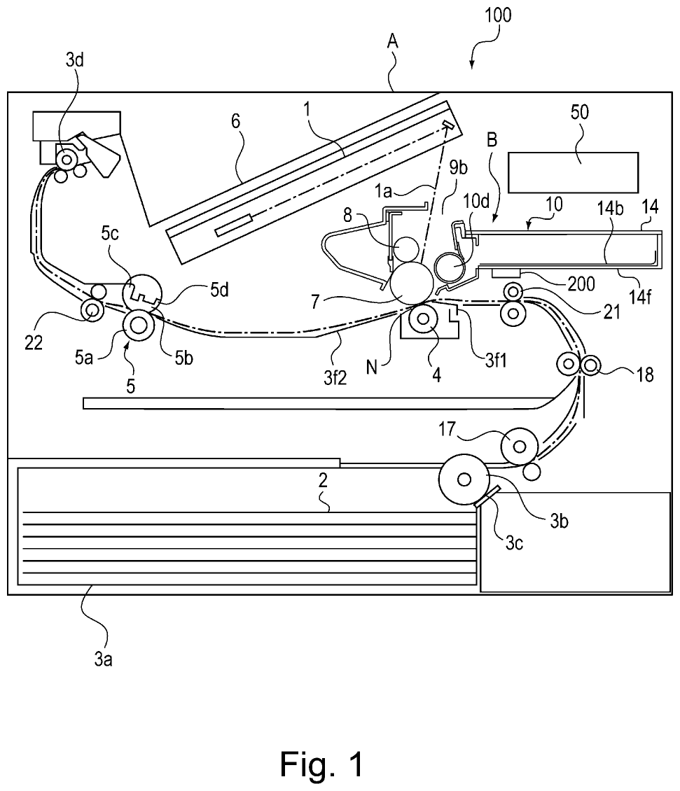

Structures of a developing device 10, the process cartridge B and the image forming apparatus 100 in a first embodiment according to the present invention will be described with reference to FIGS. 1 to 4.

### Image Forming Apparatus

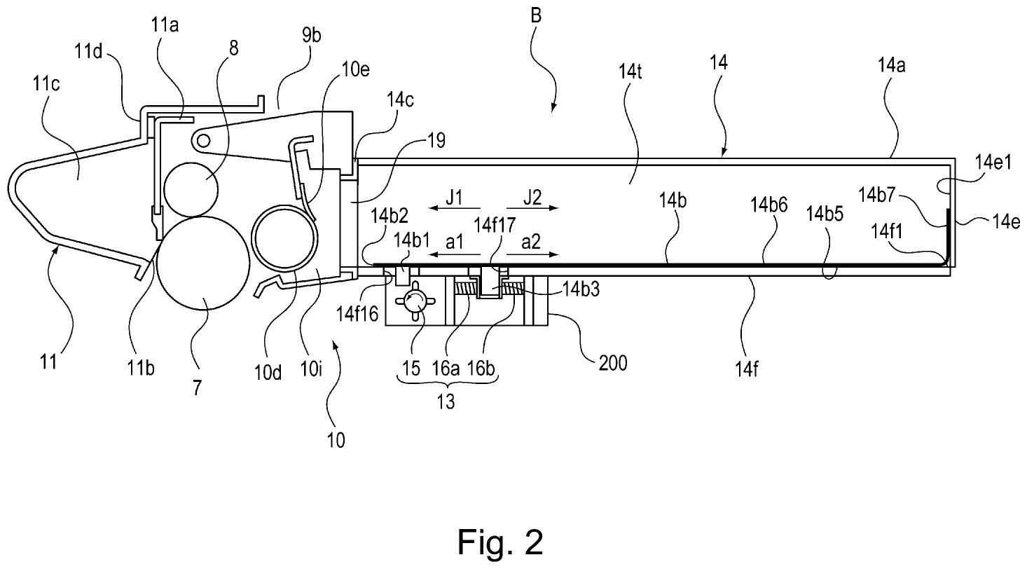

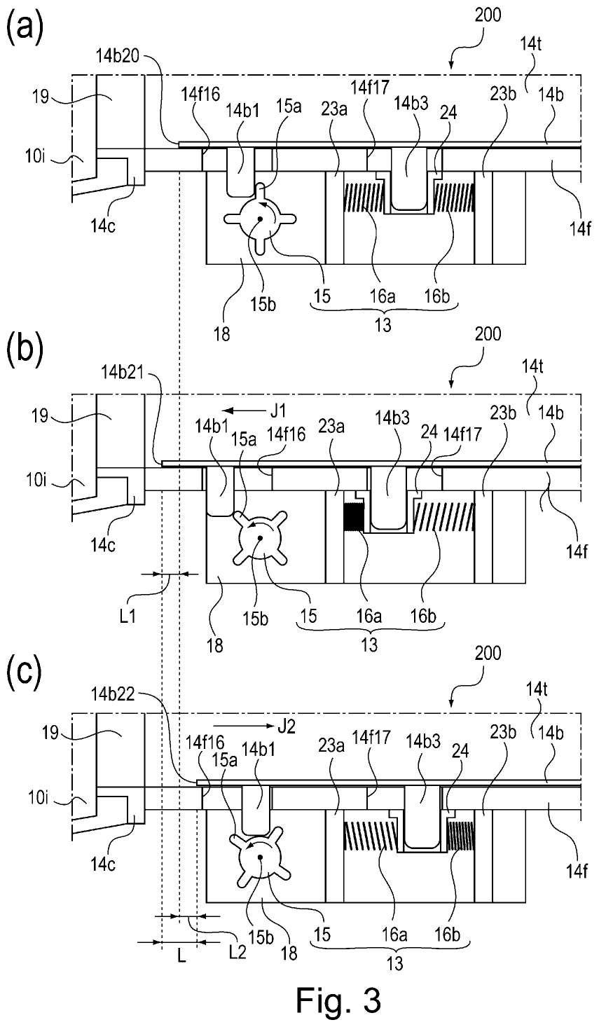

The structure of the image forming apparatus 100 will be described by using FIGS. 1 and 2. FIG. 1 is a sectional view showing the structure of the image forming apparatus 100. FIG. 2 is a sectional view showing the structure of the process cartridge B in this embodiment.

The image forming apparatus 100 shown in FIG. 1 is an example of a laser beam printer using an electrophotographic type. FIG. 1 shows a state in which the process cartridge B is mounted in the image forming position of the image forming apparatus 100.

As shown in FIG. 1, the image forming apparatus 100 includes an apparatus main assembly A and the process cartridge B mountable in and dismountable from the apparatus main assembly A. Inside the process cartridge between, a photosensitive drum 7 as an image bearing member for bearing a toner image as a developer image is rotatably provided.

In the image forming apparatus 100, a surface of the photosensitive drum 1 electrically charged uniformly by a charging roller 8 as a charging means is irradiated with laser light la, based on image information, from a laser scanner 1 as an optical means. By this, an electrostatic latent image is formed on the surface of the photosensitive drum 7. The surface of the photosensitive drum 7 is irradiated with the laser light la through an exposure opening 9b provided in the process cartridge B. The electrostatic latent image formed on the surface of the photosensitive drum 7 is developed as a toner image with toner T as a developer supplied from the developing device 10 as a developing means.

In synchronism with formation of the toner image on the surface of the photosensitive drum 7, a recording material 2 is separated and fed one by one from a feeding cassette 3a by a pick-up roller 3b and a press-contact member 3c press-contacted to the pick-up roller 3b. As the recording material 2, paper, an OHT (Over Head Transparency) sheet consisting of a transparent sheet for use with an OHP (Over Head Projector), a cloth and the like can be used.

The recording material 2 separated and fed one by one from the feeding cassette 3a is fed by a feeding roller pairs 17 and 18, and a leading end of the recording material 2 is abutted against a registration roller pair 21 which is at rest, so that oblique movement of the recording material 2 is corrected.

Thereafter, at predetermined timing, the recording material 2 is fed by the registration roller pair 21. At this time, timing when a leading end of the toner image on the surface of the photosensitive drum 7 reaches a transfer nip N formed by the photosensitive drum 7 and a transfer roller 4 as a transfer member is considered. In synchronism with that timing, the recording material 2 is fed so that the leading end thereof reaches the transfer nip N.

The recording material 2 fed by the registration roller pair 21 is fed to the transfer nip N along a feeding guide 3f1. The recording material 2 fed to the transfer nip N is subjected to transfer of the toner image, formed on the surface of the photosensitive drum 7, thereon by the transfer roller 4 to which a transfer bias is applied from an unshown transfer voltage source, and thereafter, the recording material 2 is fed toward a fixing provided 5 as a fixing means along a feeding guide 3f2.

The fixing device 5 is constituted by a driving roller 5a and a rotatable fixing member 5c constituted by a cylindrical sheet rotatably supported by a supporting member 5d incorporating therein a heater 5b. Heat and pressure are applied to the recording material 2 passing through a fixing nip formed by the driving roller 5a and the rotatable fixing member 5c, so that the transferred toner image is fixed on the recording material 2. The recording material 2 on which the toner image is fixed by the fixing device 5 is fed by discharging rollers 22 and 2d and is discharged onto a discharge tray 6.

### Process Cartridge

Next, a structure of the process cartridge B will be described using FIG. 2. The process cartridge B shown in FIG. 2 includes a cleaning unit 11 and the developing device 10 as a developing unit. Here, the process cartridge B includes the photosensitive drum 7 as an image bearing member for bearing the toner image as a developer image and at least one image forming process means. As the image forming process means, there is the charging roller 8 for electrically charging the surface of the photosensitive drum 7. In addition, there is the developing device 10 for developing the electrostatic latent image formed on the surface of the photosensitive drum 7. Further, there is a cleaning blade 11a or the like as a cleaning member for removing toner T remaining on the surface of the photosensitive drum 7 after the transfer.

### Cleaning Unit

The cleaning unit 11 includes the photosensitive drum 7, the cleaning blade 11a, the charging roller 8, an unshown residual toner feeding member and a cleaning (member) frame 11d. Further, the cleaning unit 11 is constituted by including a residual toner accommodating portion 11c for accommodating the toner T removed from the surface of the photosensitive drum 7 after the transfer and a leakage preventing sheet 11b contacting the surface of the photosensitive drum 7.

### Developing Device

The developing device 10 includes a developer container 14 for accommodating the toner T, a developing roller 10d as a rotatable developer carrying member for carrying the toner T as the developer, and a developing blade 10e as a restricting member. The developer container 14 is formed by a frame 14a for accommodating the toner T as the developer while rotatably supporting the developing roller 10d as the developer carrying member.

The developing roller 10d and the developing blade 10e are supported by the frame 14a. Inside the developer container 14, a toner accommodating portion 14t as a developer accommodating chamber in which the toner T as the developer is to be accommodated is provided, and the toner T as the developer is accommodated in the toner accommodating portion 14t. The developer container 14 is constituted by including a partition wall 14c provided with an opening 19. The partition wall 14c partitions the inside of the frame 14a into a developing chamber 10i and the toner accommodating portion 14t as the developer accommodating chamber and is provided with the opening 19 permitting communication between the developing chamber 10i and the toner accommodating portion 14t.

### Image Forming Operation

Next, by using FIGS. 1 and 2, an image forming operation of the process cartridge B will be described. First, the photosensitive drum 7 including a photosensitive layer is rotated in the clockwise direction of FIG. 1, and the surface of the photosensitive drum 1 is electrically charged uniformly by applying a charging bias voltage to the charging roller 8 as the charging means.

The uniformly charged surface of the photosensitive drum 7 is exposed to the laser light la, on the basis of image information, from the laser scanner 1 through an exposure opening 9b. By this, the electrostatic latent image is formed on the photosensitive drum 7. The electrostatic latent image formed on the surface of the photosensitive drum 7 is developed as the toner image by supplying the toner

T as the developer from the developing device 10.

The developing device 10 rotatably supports the developing roller 10d as the developer carrying member for carrying the toner T as the developer. With rotation of the developing roller 10d, a toner layer to which triboelectric charges are imparted by the developing blade 10e is formed on the surface of the developing roller 10d. Then, the toner T is transferred onto the surface of the photosensitive drum 7 depending on the electrostatic latent image, whereby the toner image is formed and visualized on the surface of the photosensitive drum 7.

Then, a voltage of an opposite polarity to the charge polarity of the toner image formed on the surface of the photosensitive drum 7 is applied to the transfer roller 4 shown in FIG. 1, so that the toner image on the surface of the photosensitive drum 7 is transferred onto the recording material 2. After the transfer, the toner T remaining on the surface of the photosensitive drum 7 is scraped off the surface of the photosensitive drum 7 by the cleaning blade 11a fixed to the cleaning frame 11d shown in FIG. 2. With this, the toner T scraped off of the surface of the photosensitive drum 7 is scooped by the leakage preventing sheet 11b and is collected in the residual toner accommodating portion 11c by an unshown residual toner feeding member. The residual toner on the surface of the photosensitive drum 7 is removed by these cleaning means.

### Developer Feeding Mechanism

Next, by using FIGS. 2 and 3, a toner feeding operation by a developer feeding mechanism 200 will be described. FIG. 3 is a sectional view showing a structure of the developer feeding mechanism 200 in this embodiment. The developer feeding mechanism 200 includes a flexible sheet member 14b provided on a bottom plate 14f of a toner accommodating portion 14t so as to be capable of reciprocal movement and includes a vibration applying member 13 for alternately reciprocating the sheet member 14b in arrow J1 and J2 directions. The vibration applying member 13 is constituted as a driving member for driving the sheet member 13 so as to reciprocate in a surface direction.

The sheet member 14b and the vibration applying member 13 as the driving member are constituted as a feeding member for feeding the toner T as the developer, in the toner accommodating portion 14t as a developer accommodating chamber, to a developing chamber 10i through the opening 19. These feeding members are disposed in the toner accommodating portion 14t as the developer accommodating chamber. The sheet member 14b is disposed inside the toner accommodating portion 14t, but the vibration applying member 13 is disposed outside the toner accommodating portion 14t.

### Sheet Member

Next, by using FIG. 2, a structure of the sheet member 14b will be described. The sheet member 14b which is a sheet-like member is disposed on an upper surface 14f1 side of the bottom plate 14f of the developer container 14 and on an inner wall surface 14e1 side of a side plate 14e provided on an opposite side from the opening 19. The sheet member 14b is disposed on a side under the toner T accommodated inside the toner accommodating portion 14t.

On a lower surface 14b5 of the sheet member 14b, a portion-to-be-contacted 14b1 to which a projection 15a of a rotatable cam member 15 contacts and a portion-to-be-urged 14b3 engaged inside a holder 24 are provided. The portion-to-be-contacted 14b1 and the portion-to-be-urged 14b3 are inserted movably in through holes 14f16 and 14f17 generating through the bottom plate 14f of the developer container 14.

Incidentally, in the through holes 14f16 and 14f17, a sealing material consisting of an elastic member such as an elastomer is provided. By this, the portion-to-be-contacted 14b1 and the portion-to-be-urged 14b3 are movable in the through holes 14f16 and 14f17 and are capable of preventing the toner T from leaking out through the through holes 14f16 and 14f17. Setting is made so that when the process cartridge B is mounted in the image forming position of the apparatus main assembly A as shown in FIG. 1, the sheet member 14b is disposed with respect to a substantially horizontal direction.

### Opening

The partition wall 14 partitions the inside of the frame 14a into the toner accommodating portion 14t and the developing chamber 10i in which the developing roller 10d as the developer carrying member is disposed, and permits communication between the toner accommodating portion 14t and the developing chamber 10i through the opening 19. The toner T accommodated inside the toner accommodating portion 14t of the developer container 14 is fed to the developing chamber 10i through the opening 19 by the sheet member 14b and is supplied to the developing roller 10d rotatably supported inside the developing chamber 10i.

### Vibration Applying (Imparting) Member

Next, by using FIG. 3, a structure of the vibration applying member 13 will be described. The vibration applying member 13 can be provided to the process cartridge B or in the apparatus main assembly A. In this embodiment, an example of the case where the vibration applying member 13 is provided in the apparatus main assembly A will be described. The vibration applying member 13 reciprocates alternately in an arrow J1 direction of part (b) of FIG. 3 and an arrow J2 direction of part (c) of FIG. 3 by imparting reciprocal acceleration in a developer feeding surface direction to the sheet member 14b along a developer feeding surface.

The vibration applying member 13 is constituted by including the cam member 15 and first and second urging members 16a and 16b. The cam member 15 is provided with projections 15a projecting in a radial direction consisting of 4 directions each deviated from each other by 90° with respect to a rotation center 15b of the cam member 15 as a center. A rotational driving force from a motor as a driving source provided on the apparatus main assembly A side is transmitted to the cam member 15. By this, when the cam member 15 is rotated in the counterclockwise direction of part (a) of FIG. 3, the projection 15a presses the portion-to-be-contacted 14b1, projected from and provided on the lower surface of the sheet member 14b, in the arrow J1 direction of part (b) of FIG. 3, and thus moves the sheet member 14b in the arrow J1 direction of part (b) of FIG. 3.

One end portion of the first urging member 16a is supported by a supporting portion 23a provided in the apparatus main assembly A, and the other end portion of the first urging member 16a is supported by the holder 24. One end portion of the second urging member 16b is supported by a supporting portion 23b, and the other end portion of the second urging member 16b is supported by the holder 24. Inside the holder 24, the portion-to-be-urged 14b3 projected from and provided on the lower surface of the sheet member 14b is engaged.

As shown in part (b) of FIG. 3, the cam member 15 is rotated in the counterclockwise direction of part (b) of FIG. 3. By this, the projection 15a of the cam member 15 presses the portion-to-be-contacted 14b1, projected from said provided on the lower surface of the sheet member 14b, in the arrow J1 direction of part (b) of FIG. 3, and thus moves the sheet member 14b in the arrow J1 direction of part (b) of FIG. 3. Then, the first urging member 16a is compressed, and the second urging member 16b is pulled.

As shown in part (c) of FIG. 3, the projection 15a of the cam member 15 passes through the portion-to-be-urged 14b1 projected from and provided on the lower surface of the sheet member 14b and then separates from the portion-to-be-contacted 14b1. Then, the first urging member 16a which has been compressed is elongated by a restoring force, so that the second urging member 16b which has been pulled is contracted (compressed) by a restoring force. The restoring forces of the first urging member 16a and the urging member 16b are transmitted to the sheet member 14b through the holder 24 and the portion-to-be-urged 14b3, so that the sheet member 14b is moved in the arrow J2 direction of part (c) of FIG. 3.

By rotation of the cam member 15, the sheet member 14b repeats operations of parts (a) to (c) of FIG. 3, so that the sheet member 14b vibrates alternately in the arrow J1 direction of part (b) of FIG. 3 and the arrow J2 direction of part (c) of FIG. 3. Thus, the sheet member 14b vibrates alternately in the arrow J1 and J2 direction of FIG. 2 at the inside of the toner accommodating portion 14t, so that the toner T on the sheet member 14b is fed by the sheet member 14b in the arrow J1 direction of FIG. 2 which is the developer feeding direction.

Setting of maximum acceleration a1 of the sheet member 14b in the arrow J1 direction is adjustable by the number of rotations of the cam member 15. Further, setting of maximum acceleration a2 of the sheet member 14b in the arrow J1 direction is adjustable by adjusting the urging forces of the first and second urging members 16a and 16b. In this embodiment, in order to provide acceleration by which the toner T slides on the sheet member 14b, the maximum acceleration a1 is set so as to be smaller than the maximum acceleration a2 (a1<a2).

That is, the sheet member 14b driven by the vibration applying member 13 as the driving member moves the toner T, as the developer accommodated inside the toner accommodating portion 14t as the developer container, toward the opening 19 side (opening side). At this time, the maximum acceleration a1 in the arrow J1 direction as a first direction is smaller than the maximum acceleration a2 in the arrow J2 direction as a second direction.

The maximum acceleration a1 in the developer feeding direction shown as the arrow J1 direction of FIG. 2 is set so as to be smaller than the maximum acceleration a2 in the arrow J2 direction of FIG. 2. By this, a distance in which the toner t slides on the sheet member 14b is longer during movement of the toner T in the arrow J2 direction than during movement of the toner T in the developer feeding direction shown as the first direction.

Further, when the sheet member 14b moves in the arrow J2 direction, the toner T slidable on the sheet member 14b moves in the developer feeding direction shown as the arrow J1 direction relative to the arrow J2 direction. By this principle, the sheet member 14b repeats the above-described operations, so that the toner T on the sheet member 14b is gradually fed in one direction which is the developer feeding direction shown as the arrow J1 direction. By this, the toner T on the sheet member 14b can be fed in the arrow J1 direction, of part (b) of FIG. 3, which is the developer feeding direction.

By the vibration applying member 13, the sheet member 14b vibrates through the portion-to-be-contacted 14b1 and the portion-to-be-urged 14b3 in a feeding surface direction crossing a thickness direction of the sheet member 14b. At this time, to the sheet member 14b, the maximum acceleration a1 in the arrow J1 direction and the maximum acceleration a2 in the arrow J2 direction are applied.

Here, an initial position 14b20 where the sheet member 14b is mounted on the vibration applying member 13 as shown in part (a) of FIG. 3 will be considered. Further, a position 14b21 where the sheet member 14b is most moved in the arrow J1 direction as shown in part (b) of FIG. 3 will be considered. Further, a position 14b22 where the sheet member 14b is most moved in the arrow J2 direction opposite to the arrow J1 direction as shown in part (c) of FIG. 3 will be considered. At this time, a leading end 14b2 of the sheet member 14b moves from the initial position 14b20 shown in part (a) of FIG. 3 to between the position 14b21 shown in part (b) of FIG. 3 and the position 14b22 shown in part (c) of FIG. 3. By this, the sheet member 14b reciprocates in the feeding surface direction.

A vibration frequency of the vibration applying member 13 at this time is 20 Hz. Here, the position 14b21 where the leading end 14b2 of the sheet member 14b most moves in the arrow J1 direction shown in part (b) of FIG. 3 will be considered. Further, the position 14b22 where the leading end 14b2 of the sheet member 14b most moves in the arrow J2 direction shown in part (c) of FIG. 3 will be considered.

A movement distance L (=L1+L2) of the leading end 14b2, which is a difference between the position 14b21 shown in part (b) of FIG. 3 and the position 14b22 shown in part (c) of FIG. 3 is set at about 3 mm.

The vibration applying member 13 is not limited to the structure shown in FIG. 3. In this embodiment, the case where the portion-to-be-contacted provided on the sheet member 14b capable of reciprocal movement in the feeding surface direction crossing the thickness direction of the sheet member 14b is moved by rotation of the cam member 15 was described as an example. As another example of the vibration applying member, the portion-to-be-contacted 14b1 may also be moved by a vibrating device such as a piezoelectric element.

### Structure in Which Sheet Member Reciprocates Along Inner Surface of Developer Container

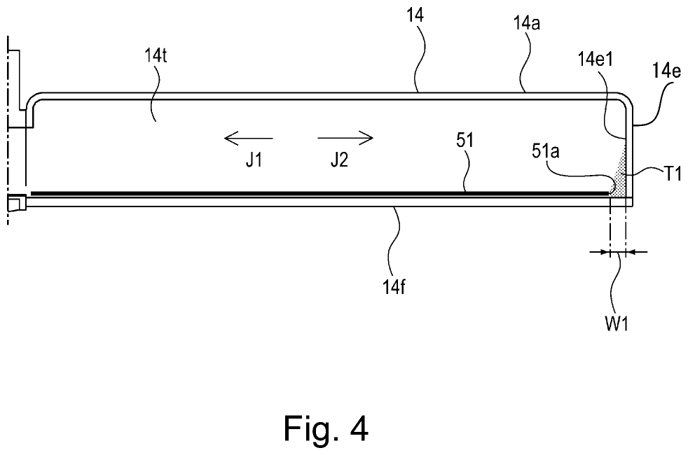

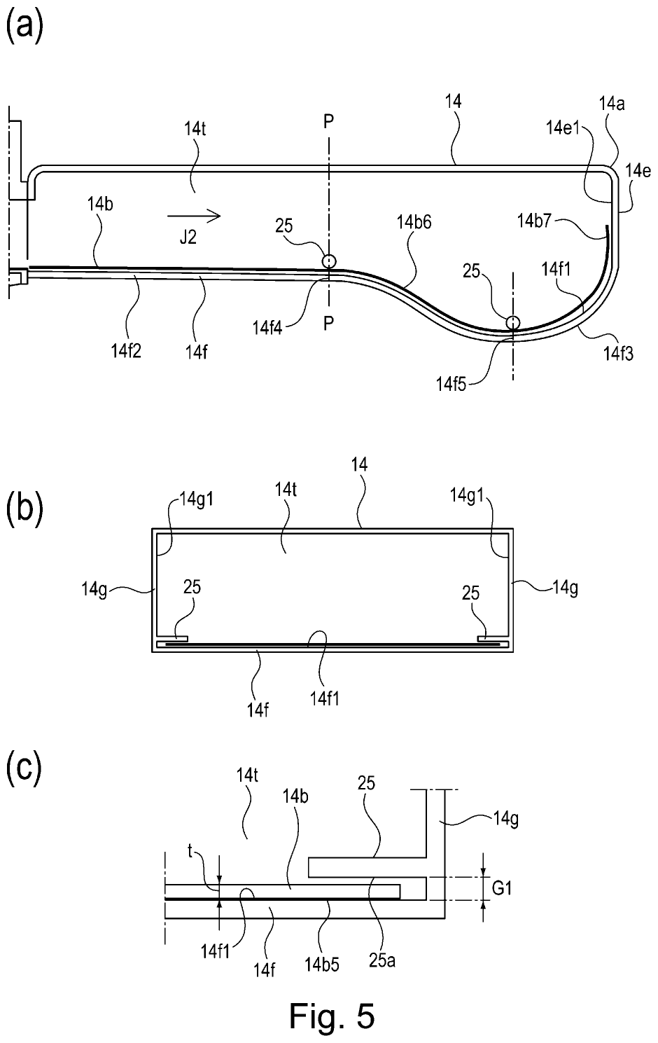

Next, a structure in which the sheet member 14b reciprocates along the inner wall surface of the developer container 14 will be described using a first comparison example shown in FIG. 4 and this embodiment shown in FIG. 2.

### First Comparison Example

FIG. 4 is a sectional view showing a structure of a developer container 14 in the first comparison example. In the first comparison example shown in FIG. 4, a plate-like member 51 has a uniform flat surface. When the plate-like member 51 reciprocates in arrow J1 and J2 direction of FIG. 4, a trailing end 51a of the plate-like member 51 on the arrow J2 direction side is prevented from contacting an inner wall surface 14e1 of a side plate 14e of a developer container 14.

This is because impact noise when the trailing end 51a of the plate-like member 51 movable in the arrow J2 direction of FIG. 4 contacts the inner wall surface 14e1 of the side plate 14e of the developer container 14 is prevented. For this purpose, at a position where the trailing end 51a of the plate like member 51 most moved in the arrow J2 direction, a gap W1 is provided between the trailing end 51a of the plate-like member 51 and the side plate 14e of the developer container 14. As a result, residual toner T1 remains in the gap W1.

In this embodiment shown in FIG. 2, compared with the plate-like member 51 in the first comparison example shown in FIG. 4, the flexible sheet member 14b is longer than a length, in the arrow J2 direction, of the bottom of the toner accommodating portion 14t defined by the upper surface 14f1 of the bottom plate 14f of the developer container 14. When the sheet member 14b is driven by the vibration applying member 13 as the driving member, the sheet member 14b deforms in a shape following a shape from the upper surface 14f1 of the bottom plate 14f as the inner wall surface of the toner accommodating portion 14t at the developer accommodating chamber to the inner wall surface 14e1 of the side plate 14e.

The case where the process cartridge B is mounted in the image forming position of the image forming apparatus 100 shown in FIG. 1 and the developing device 10 is in an attitude during use will be considered. In this attitude, the case where the sheet member 14b is moved along the arrow J2 direction as the second direction will be considered.

In this case, the sheet member 14b includes, as shown in FIG. 2, a first portion 14b6 extending along the upper surface 14f1 of the bottom plate 14f as the bottom of the toner accommodating portion 14t as the developer accommodating chamber. Further, the sheet member 14b includes a second portion 14b7 extending along the inner wall surface 14e1 of the side plate 14e as a side surface of the toner accommodating portion 14t. The sheet member 14b flexes along the upper surface 14f1 of the bottom plate 14f and the inner wall surface 14e1 of the side plate 14e, so that the first portion 14b6 and the second portion 14b7 are formed.

The sheet member 14b reciprocates along the inner wall surface of the toner accommodating portion 14t as the developer accommodating chamber with deformation. At this time, the sheet member 14b moves along not only the upper surface 14f1 of the bottom plate 14f but also the inner wall surface 14e1 of the side plate 14e. By this, the toner T deposited on the inner wall surface 14e1 of the side plate 14e is scraped off and can be efficiently fed. The sheet member 14b may also have the same shape as the shape of the inner wall surface of the toner accommodating portion 14t and may only be required to be capable of being deformed in a shape following the inner wall surface of the toner accommodating portion 14t. That is, there is no need that the sheet member 14b has exactly the same shape as the inner wall surface of the toner accommodating portion 14t.

As the sheet member 14b, a 1.5 mm-thick polystyrene (PS) was used. Further, it is possible to use polyethylene terephthalate (PET) and polyethylene (PE). Thus, as the sheet member 14b, such a flexible material can be used.

As described above, the sheet member 14b formed of the flexible material reciprocates along the inner wall surface of the developer container 14 with deformation. By this, even in the case where the inner wall surface of the developer container 14 is a curved surface or includes a plurality of flat surfaces, different from the first comparison example shown in FIG. 4, the residual toner T1 does not remain inside the toner accommodating portion 14t, so that feeding of the toner T can be effectively carried out in this embodiment.

### Second Embodiment

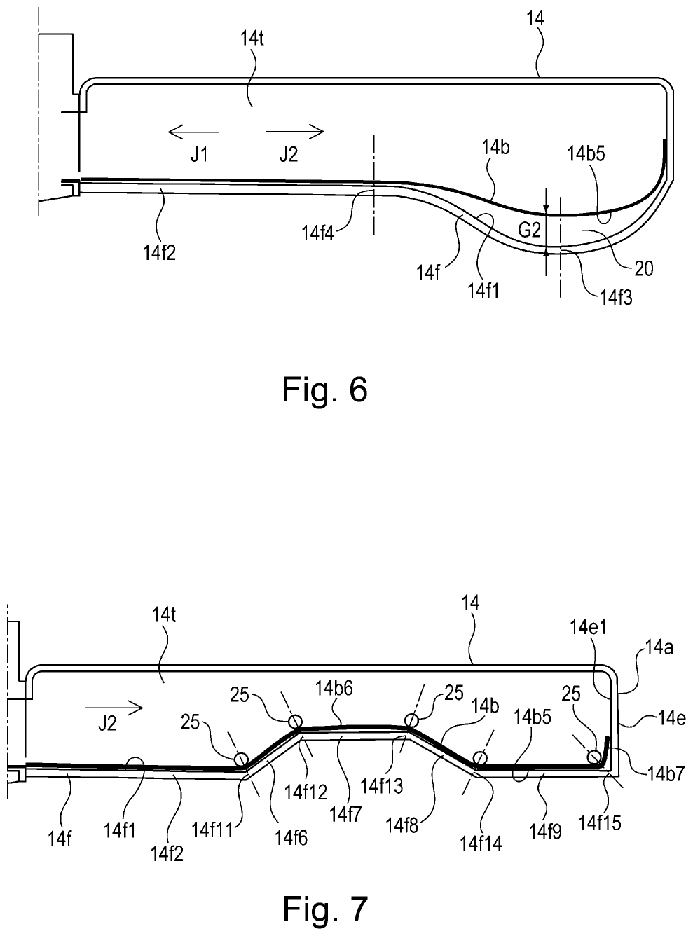

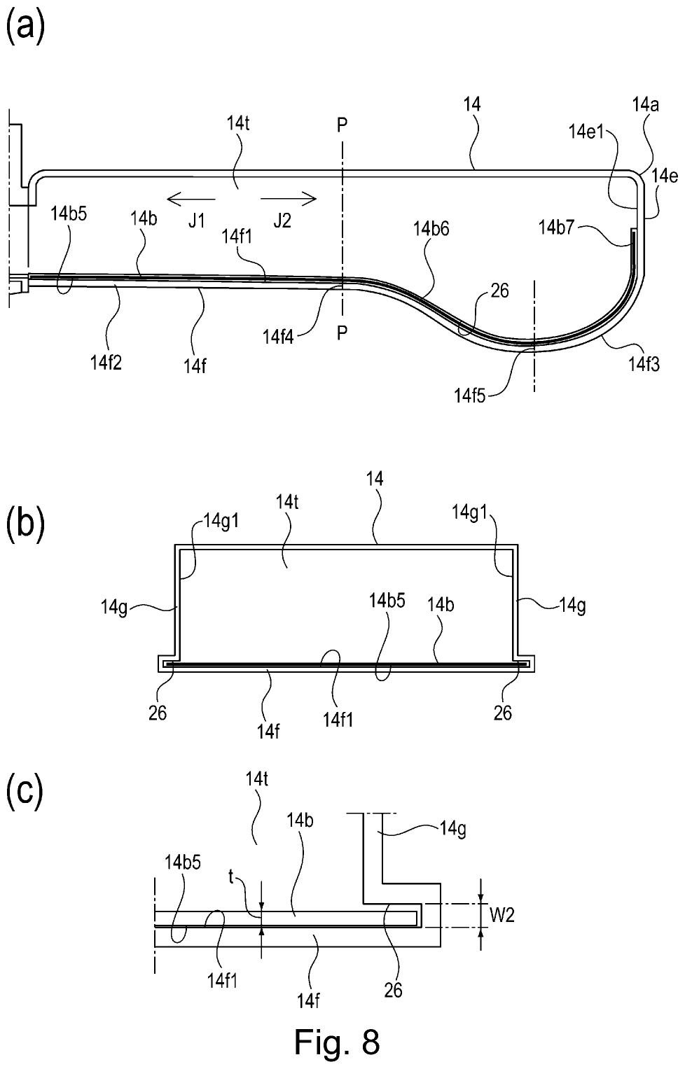

Next, a structure of a developing device 10 in a second embodiment according to the present invention will be described with reference to FIGS. 5 to 7. Incidentally, constituent elements constituted similarly as in the above-described first embodiment will be omitted from description by adding thereto the same reference numerals or symbols or by adding thereto the same member (part) names even when the reference numerals or symbols are different from those in the first embodiment. Part (a) of FIG. 5 is a sectional view showing a structure of the developer container 14 in this embodiment. Part (b) of FIG. 5 is a sectional view taken along P-P line of part (a) of FIG. 5. Part (c) of FIG. 5 is a partially enlarged view of part (b) of FIG. 5. FIG. 6 is a sectional view showing a structure of a developer container 14 in a second comparison example. FIG. 7 is a sectional view showing a structure of a developer container 14 in a modified embodiment of this embodiment.

As shown in part (a) of FIG. 5, the bottom plate 14f of the developer container 14 in this embodiment is constituted by including a flat surface portion 14f2 and a curved surface portion 14f3. The frame 14a of the developer container 14 is provided with a restricting member 25 so as to be contacted to the sheet member 14b. The restricting member 25 restricts deformation of the sheet member 14b to a predetermined shape by contact with the sheet member 14b when the sheet member 14b is deformed.

The restricting member 25 is constituted by a projection projecting from the inner wall surface of the frame 14a toward an inside of the frame 14a. The restricting member 25 consisting of the projection is provided on an inner wall surface 14g1 of a side plate 14g (part (b) of FIG. 5) as a side surface of the toner accommodating portion 14t as the developer accommodating chamber so as to project inward. The restricting member 25 is disposed at a plurality of different positions with respect to the arrow J2 direction as the second direction.

The restricting member 25 is provided above the sheet member 14b or inside the toner accommodating portion 14t than the sheet member 14b is, so as to sandwich the sheet member 14b between the bottom plate 14f and the side plate 14e of the developer container 14. The restricting member 25 is provided on the inner wall surface of the toner accommodating portion 14t as the developer container 14. The restricting member 25 contacts the sheet member 14b and restricts an operation of the sheet member 14b.

As shown in part (c) of FIG. 5, a gap G1 between an upper surface 14f1 of the bottom plate 14f of the developer container 14 and a lower end 25a of the restricting member 25 was 2 mm larger than 1.5 mm which is a thickness of the sheet member 14b. The upper surface 14f1 of the bottom plate 14f as the inner wall surface of the toner accommodating portion 14t as the developer accommodating chamber includes the flat surface portion 14f2 and the curved surface portion 14f3.

The restricting member 25 is provided in the neighborhood of an inflection point 14f4 between the flat surface portion 14f2 and the curved surface portion 14f3 of the bottom plate 14f of the developer container 14 shown in part (a) of FIG. 5 and in the neighborhood of an inflection point 14f5 positioned at a valley (point) of the cured surface portion 14f3. Here, the inflection point refers to a point where a curving direction of a curve of the upper surface 14f1 of the bottom plate 14f of the developer container 14 changes. The restricting member 25 is provided at positions corresponding to at least the inflection points 14f4 and 14f5 of the curved surface portion 14f3. The sheet member 14b contacts the restricting member 25 and deforms in the neighborhood of the inflection point 14f4 of the bottom plate 14f of the developer container 14, and thus is capable of moving along the curve of the upper surface 14f1 of the bottom plate 14f.

### Second Comparison Example

Next, by using FIG. 6, a second comparison example in which there are no restricting member 25 shown in parts (a) to (c) of FIG. 5 will be described. In the second comparison example shown in FIG. 6, an example of the case where the restricting member 25 is not used, and therefore, the sheet member 14b cannot move along the curve of the upper surface 14f1 of the bottom plate 14f of the developer container 14 is shown. In this case, a space 20 is created between the lower surface 14b5 of the sheet member 14b and the upper surface 14f1 of the bottom plate 14f of the developer container 14. In the case where in this state, the toner T is intended to be fed by reciprocal movement of the sheet member 14b in the arrow J1 and J2 directions, the toner T remains in the space 20, so that the toner T cannot be efficiently fed.

In this embodiment shown in FIG. 5, the sheet member 14b passes through the gap G1 between the lower end 25a of the restricting member 25 provided in the neighborhood of each of the inflection points 14f4 and 14f5 of the bottom plate 14f of the developer container 14 and the upper surface 14f1 of the bottom plate 14f of the developer container 14. By this, the sheet member 14b can smoothly move along the curved surface of the upper surface 14f1 of the bottom plate 14f of the developer container 14. As a result, a gap G2 between the lower surface 14b5 of the sheet member 14b and the upper surface 14f1 of the bottom plate 14f of the developer container 14 does not become large, so that different from the second comparison example shown in FIG. 6, the toner T does not remain in the space 20. By this, the toner T can be efficiently fed.

The restricting member 25 is disposed in the neighborhood of each of the inflection points 14f4 and 14f5 of the curved surface of the upper surface 14f1 of the bottom plate 14f of the developer container 14. By this, the number of the restricting members 25 can be reduced, so that the sheet member 14b can be efficiently deformed. The sheet member 14b may only be required to be movable along the upper surface 14f1 of the bottom plate 14f of the developer container 14 and the inner wall surface 14e1 of the side plate 14e while being restricted by the restricting members 25. For this reason, the restricting member 25 can be disposed at the inflection points 14f4 and 14f5 of the curved surface of the upper surface 14f1 of the bottom plate 14f of the developer container 14 and also at a position other than the inflection points 14f4 and 14f5. As the restricting member 25 in this embodiment, a projection of 3 mm in outer diameter was used.

### Modified Embodiment

Next, a modified embodiment of this embodiment will be described using FIG. 7. In FIG. 5, an example of the case where the bottom plate 14f of the developer container 14 includes the curved surface portion 14f3 was shown. In this modified embodiment shown in FIG. 7, an example in which the bottom plate 14f of the developer container 14 is constituted by including a plurality of flat surface portions 14f2 and 14f6 to 14f9 is described.

A restricting member 25 is provided in the neighborhood of a bent point 14f11 between the flat surface portions 14f2 and 14f6. Further, restricting members 25 are provided in the neighborhood of a bent point 14f12 between the flat surface portions 14f6 and 14f7 and in the neighborhood of a bent point 14f3 between the flat surface portions 14f7 and 14f8. In addition, restricting members 25 are provided in the neighborhood of a bent point 14f14 between the flat surface portions 14f8 and 14f9 and in the neighborhood of a bent point 14f15 between the flat surface portion 14f9 and the side plate 14e.

Thus, the upper surface 14f1 of the bottom plate 14f as the inner wall surface of the toner accommodating portion 14t as the developer accommodating chamber includes the plurality of flat surface portions 14f2 and 14f6 to 14f9. The restricting members 25 are provided at positions corresponding to at least the bent points 14f11 to 14f15 of the respective flat surface portions 14f2 and 14f6 to 14f9. As each of the restricting members 25, a projection projecting from the inner wall surface 14f1 of the side plate 14g of the developer container 14 toward the inside of the developer container 14.

As shown in FIG. 7, the case where the bottom plate 14f of the developer container 14 is constituted by including the plurality of flat surface portions 14f2 and 14f6 to 14f9 will be considered.

Even in such a case, the sheet member 14b passes through the gap G1 between the lower end 25a of the restricting member 25 provided in the neighborhood of each of the bent points 14f11 to 14f15 of the bottom plate 14f of the developer container 14 and the upper surface 14f1 of the bottom plate 14f of the developer container 14. By this, the sheet member 14b can smoothly move along the plurality of flat surface portions 14f2 and 14f6 to 14f9 of the upper surface 14f1 of the bottom plate 14f of the developer container 14. As a result, a gap G2 between the lower surface 14b5 of the sheet member 14b and the upper surface 14f1 of the bottom plate 14f of the developer container 14 does not become large, so that different from the second comparison example shown in FIG. 6, the toner T does not remain in the space 20. By this, feeding of the toner T can be efficiently carried out. Thus, a degree of freedom of design of the shape of the bottom plate 14f of the developer container 14 is improved. Other constituent elements are constituted similarly as those in the first embodiment, and a similar effect can be obtained.

### Third Embodiment

Next, structures of a developing device 10 in a third embodiment according to the present invention will be described with reference to FIG. 8. Incidentally, constituent elements constituted similarly as in the above-described respective embodiments will be omitted from description by adding thereto the same reference numerals or symbols or by adding thereto the same member (part) names even when the reference numerals or symbols are different from those in the respective embodiments. Part (a) of FIG. 8 is a sectional view showing a structure of a developer container 14 in this embodiment. this embodiment. Part (b) of FIG. 8 is a sectional view taken along P-P line of part (a) of FIG. 8. Part (c) of FIG. 8 is a partially enlarged view of part (b) of FIG. 8.

Each of restricting members 26 shown in parts (a) to (c) of FIG. 8 in this embodiment is constituted by a groove portion formed at the inner wall surface 14g1 of the side plate 14g of the frame 14a of the developer container 14. The groove portion as the restricting member 26 is constituted by a U-shape when the side plate 14g is cut in a direction perpendicular to the arrow J1 and J2 directions. Each of opposite end portions of the sheet member 14b is movably engaged in the associated groove portion as the restricting member 26.

The restricting member 26 which is the groove portion for restricting motion (movement) of the sheet member 14b is formed by a curve extending along the bottom plate 14f of the developer container 14. Further, in order to permit smooth reciprocal movement of the sheet member 14b, a groove width W2 of the restricting member 26 shown in part (c) of FIG. 8 was 2 mm larger than 1.5 mm which is a thickness t of the sheet member 14b.

By this, the sheet member 14b can smoothly slide along a wall surface of the groove portion in the groove portion of the restricting member 26 and thus can move along the upper surface 14f1 of the bottom plate 14f of the developer container 14. As a result, the gap G2 (FIG. 6) between the lower surface 14b5 of the sheet member 14b and the upper surface 14f1 of the bottom plate 14f of the developer container 14 does not become large, so that different from the second comparison example shown in FIG. 6, the toner T does not remain in the space 20. By this, the toner T can be efficiently fed.

In this embodiment, the restricting member 26 consisting of the groove portion was provided over an entire region of the inner wall surface 14g1 of the side plate 14g. As another example, the restricting member 26 consisting of the groove portion may also be provided on the inner wall surface 14g1 of the side plate 14g at each of positions of inflection points 14f4 and 14f5 of the bottom plate 14f of the developer container 14. Further, in order to prevent the sheet member 14b from contacting the upper surface 14g1 of the bottom plate 14f of the developer container 14, the restricting member 26 consisting of the groove portion may also be provided, at a position above the upper surface 14f1 of the bottom plate 14f, on the inner wall surface 14g1 of the side plate 14g. Other constituent elements are constituted similarly as those in the above-described embodiments, and a similar effect can be obtained.

According to the present invention, feeding efficiency of the developer can be improved.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-065535 filed on Mar. 29, 2019, which is hereby incorporated by reference herein in its entirety.

1. A developing device comprising:
a rotatable developer carrying member configured to carry a developer;
a frame rotatably supporting said developer carrying member and configured to accommodate the developer;
a partition wall configured to partition an inside of said frame into a developing chamber in which said developer carrying member is provided and a developer accommodating portion in which the developer is accommodated, said partition wall being provided with an opening permitting communication between said developing chamber and said developer accommodating chamber; and
a feeding member configured to feed the developer from said developer accommodating chamber to said developing chamber through said opening,
wherein said feeding member includes a flexible sheet member and a driving member configured to drive said sheet member so as to reciprocate in a surface direction,
wherein maximum acceleration of said sheet member driven by said driving member in a first direction in which the developer in said developer accommodating chamber is moved toward said opening is smaller than maximum acceleration thereof in a second direction opposite to the first direction, and
wherein when said sheet member is reciprocated in the surface direction by said driving member, said sheet member is deformable so as to follow a shape of an inner wall surface of said developer accommodating chamber.

2. A developing device according to claim 1, wherein when said sheet member is moved along the second direction in an attitude during use, said sheet member includes a first portion following a bottom of said developer accommodating chamber and a second portion following a side surface of said developer accommodating chamber.

3. A developing device according to claim 2, wherein said sheet member is flexed along the bottom and the side surface of said developer accommodating chamber, and thus said first portion and second portion are formed.

4. A developing device according to claim 3, further comprising a restricting member provided in said frame so as to be contactable to said sheet member and configured to restrict deformation of said sheet member to a predetermined shape when said sheet member is deformed by contacting with said restricting member.

5. A developing device according to claim 4, wherein said restricting member is constituted by a projection projecting inward from the inner wall surface of said frame.

6. A developing device according to claim 5, wherein said projection is provided on the side surface of said developer accommodating chamber.

7. A developing device according to claim 4, wherein said restricting member is constituted by a groove formed on the inner wall surface of said frame.

8. A developing device according to claim 4, wherein said restricting member is disposed at a plurality of different positions with respect to the second direction.

9. A developing device according to claim 4, wherein the inner wall surface of said developer accommodating chamber has a curved surface portion, and said restricting member is provided at a position corresponding to at least an inflection point of the curved surface portion.

10. A developing device according to claim 4, wherein the inner wall surface of said developer accommodating chamber includes a plurality of flat surface portions, and said restricting member is provided at a position corresponding to at least a bent point of the flat surface portions.

11. A process cartridge comprising:
a developing device according to claim 1; and
an image bearing member configured to bear a developer image.

12. A image forming apparatus comprising:
developing device according to claim 1; and
a transfer member.

13. A process cartridge according to claim 11; and
a transfer member.
